(19) United States
(12) Patent Application Publication
(10) Pub. No.: US 2026/0241465 A1
(43) Pub. Date: Aug. 20, 2026

(54) Guide Bushing System

(71) Applicant: JBS SYSTEM GMBH, Kronshagen (DE)

(72) Inventor: Maik JESS, Kronshagen (DE)

(73) Assignee: JBS SYSTEM GMBH, Kronshagen (DE)

(21) Appl. No.: 19/131,835

(22) PCT Filed: Jan. 30, 2024
(86) PCT No.: PCT/DE2024/100079

§ 371 Date: May 21, 2025

(30) Foreign Application Priority Data
Jan. 31, 2023 (DE) 10 2023 102 279.2

(51) Int. Cl. B23B 31/20

(52) U.S. Cl. CPC B23B 31/2073; B23B 31/202

(57) ABSTRACT

A guide bushing system comprising a guide bushing configured to receive a guide collet. A plurality of guide clamps of different types can be introduced into the guide bushing. A drive is configured to carry out an axial movement of at least one of the guide collets within the guide bushing. A plurality of spindle caps wherein each cap is adapted to at least one type of one of the plurality of guide clamps, wherein each spindle cap of the plurality of spindle caps can be connected to the guide bushing for cooperation with the guide clamp to which the respective spindle cap is adapted.

The invention relates to a guide bush. In particular, the invention relates to a guide bush set up to receive a guide collet with a drive acting on the guide collet and set up to execute an axial movement of a guide collet within the guide bush, a guide collet which can be inserted into the guide bush and a spindle cap which is adapted to the design of the guide collet and can be connected to the guide bush. The design refers to the design of the guide collets as a pull-type guide collet or a thrust-type guide collet or a double-cone guide collet or a standard guide collet.

Guide bushes and collets, which are known from DE 10 2017 105 872A1, DE 10 2014 018 695 4 and DE 10 2017 123 811B3 , for example, are used to hold and guide a bar of material to be machined during the machining process and to support it against machining forces. In this way, very long and slim workpieces can be produced with low machining tolerances. Fluctuations in the diameter of the material bar are compensated for with the guide bushes so that bars with different diameters can always be processed with the same guide bush.

In practice, however, it regularly happens that different types of collets are required for machining workpieces, so that the entire guide bush has to be removed and replaced with another guide bush that has a guide collet of the desired type.

The disadvantages of this procedure are the high material, time and labour costs involved in holding and replacing the guide bush.

It is therefore an object of the invention to create a simply constructed and universally usable guide bush that can be used with guide collets of different designs.

According to the invention, this object is solved by the guide bush system with the features of claim 1. The dependent claims disclose advantageous embodiments of the invention.

The basic idea of the invention is to create a guide bushing system with a guide bush that does not require any special adaptations to accommodate a collet, so that in principle any guide collet of a plurality of differently designed guide collets can be inserted into the guide bush of the system according to the invention. At the same time, a plurality of spindle caps adapted in each case to at least one design of one of the plurality of guide collets is provided, each spindle cap being connectable to the guide bush and, in the state connected to the guide bush, co-operating with the guide collet to which the spindle cap is adapted.

In particular, the spindle caps of the system designed according to the invention have bevelled edges adapted to the type of guide collets. For example, when using a double-cone collet, a bevelled start is required on the side of the spindle cap facing the guide bush, whereas when using pull-type collet, a bevelled start is required on the side of the spindle cap facing away from the guide bush.

If necessary, the system also has a plurality of actuators, each adapted to at least one design of one of the plurality of guide collets, which can also be exchanged as required and connected on the one hand to co-operate with the drive and on the other hand to co-operate with the guide collet to which the respective actuator is adapted.

According to the invention, a guide bushing system is thus proposed with a guide bush set up to receive a guide collet, a plurality of guide collets of different types which can be inserted into the guide bush, a drive set up to execute an axial movement of at least one of the guide collets within the guide bush, and a plurality of spindle caps each adapted to at least one design of one of the plurality of guide collets, wherein each spindle cap of the plurality of spindle caps can be connected to the guide bush for co-operation with the guide collet to which the respective spindle cap is adapted.

The guide bushing system is therefore designed in such a way that each guide collet of the system can be inserted into the guide bush and put into operation by means of a spindle cap designed to match the design of the guide collet. Although the spindle caps can be connected to the guide bush using different connecting means, it is preferable for the spindle caps to be connected to the guide bush using an identical connecting means. The connecting means can be designed as an independent element or be a device formed on the guide bush and/or the guide collets, e.g. a thread.

A plurality of actuators each adapted to at least one design of one of the plurality of guide collets is also preferably provided, each actuator being set up to co-operate with the drive and with the guide collet to which the respective actuator is adapted.

The plurality of guide collets preferably has at least one pull collet and/or at least one thrust collet and/or at least one double-cone collet and/or a standard guide collet. In particular, it is envisaged that the plurality of guide collets has at least two guide collets of different designs selected from the group of guide collets comprising a pull-type guide collet, a thrust collet, double-cone collet and a standard guide collet. In particular, it is envisaged that the plurality of guide collets comprises a pull collet and a thrust collet or a double-cone collet or a standard collet. Alternatively, it is envisaged that the plurality of guide collets comprises a double-cone collet and a pull collet or a thrust collet or a standard guide collet. As a further alternative, it is envisaged that the plurality of guide collets comprises a thrust collet and a double-cone collet or a pull collet or a standard guide collet. Finally, it is alternatively provided that the plurality of guide collets comprises a standard guide collet and a thrust collet or a double-cone collet or a pull collet. Accordingly, it is particularly preferable for the plurality of actuators to have at least one pull piece and/or one thrust piece. In the case of standard guide collets, a pull piece is also preferably provided, although the inside diameter remains constant when the standard guide collets are used, i.e. during operation of the guide bush, and does not undergo any radial adjustment. This is ensured by inserting the standard guide collet into the guide bush to a predetermined depth and thus a predetermined internal diameter, in particular by screwing it in and fixing it in place and, in particular, by also putting the drive out of operation.

It is particularly preferable for each actuator of the multiple actuators to be detachably connected to the drive.

Finally, each spindle cap preferably has a thread that is set up to screw with a thread provided on the guide bush. Such a design enables the spindle cap to be securely and precisely attached to the guide bush and allows the spindle cap, the guide clamp and, if necessary, the actuator to be replaced quickly.

The invention is explained in more detail below with reference to a particularly preferably designed embodiment shown in the accompanying drawings. These show:

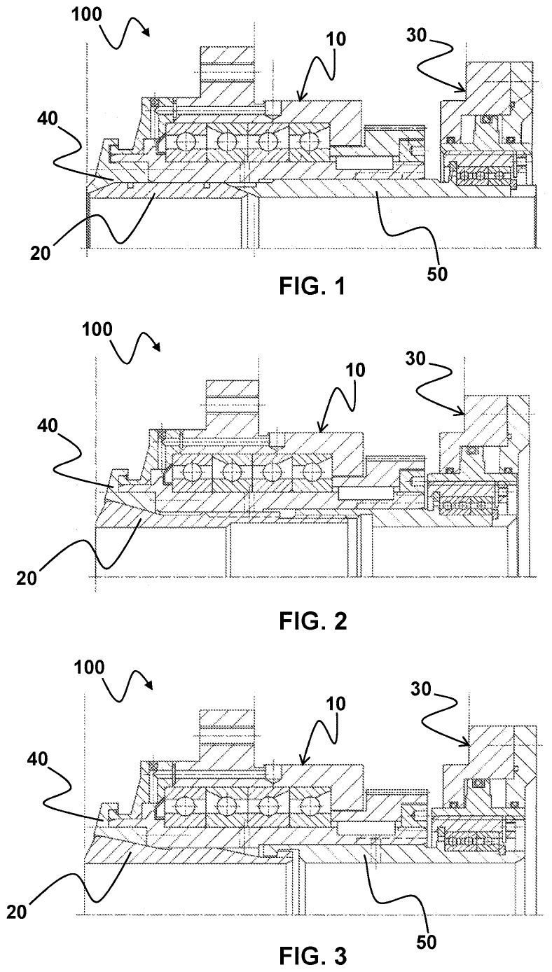

FIG. 1 a particularly favoured embodiment of a guide bush equipped with a double-cone collet;

FIG. 2 the particularly preferably designed guide bush, which is equipped with a standard guide collet; and

FIG. 3 the particularly preferably designed guide bush, which is equipped with a pull collet.

The figures thus show, in their entirety, a guide bushing system 100 with a guide bush 10 designed to receive in each case one guide collet 20, wherein the guide collet 20 received by the guide bush 10 in the figures are selected from a plurality of guide collets 20 of different design which can be inserted into the guide bush 10, and in FIG. 1 is designed as a double-cone collet, in FIG. 2 as a standard guide collet and in FIG. 3 as a pull-collet.

The guide bush has a drive 30 set up within the guide bush 10 to execute an axial movement of at least one of these guide collets 20, namely the double-cone collet shown in FIG. 1 and the thrust collet shown in FIG. 3. Depending on the design of the guide collet 20 inserted into the guide bush 10, the drive 30 has a pull or thrust piece 50, which can be detachably connected to the drive 30. It can be seen in FIG. 1 that the drive 30 has a thrust piece 50 acting on the double-cone collet 20, whereas the drive 30 in FIG. 3 is equipped with a pull piece 50 acting on the pull collet 50.

In the case of the standard guide collet shown in FIG. 2, the drive is without a function, since the standard guide collet has an inner diameter which is invariable during the operation of the guide bush. It is merely ensured by suitable fixing that the standard guide collet cannot be displaced axially.

Finally, it can be seen in the figures that a plurality of spindle caps 40 each adapted to at least one design of one of the plurality of guide collets 20 is provided, wherein each spindle cap 40 of the plurality of spindle caps 40 is connectable to the guide bush 10 for co-operation with that guide collet 20 to which the respective spindle cap 40 is adapted. In particular, it can be seen in the figures that the spindle cap 40 used in FIG. 1 for the double-cone collet differs from the spindle cap 40 used in FIG. 2 for the standard guide collet and in FIG. 3 for the pull collet. In any case, the spindle cap 40 has a thread which is designed to be screwed to a thread provided on the guide bush 10.

In the case of the double-cone collet shown in FIG. 1 and the pull collet shown in FIG. 3, the spindle cap 40 forms a run-on slope adapted to the respective type of guide collet. In the case of the standard guide collet shown in FIG. 2, the spindle cap 40 for the standard guide collet forms a contact surface delimiting the axial penetration depth into the guide bush 10.

1. A guide bushing system comprising:
a guide bush designed to receive a guide collet
a plurality of guide collets of different design which can be inserted into the guide bush,
a drive designed to carry out an axial movement of at least one of the guide collets within the guide bush, and
a plurality of spindle caps each adapted to at least one design of one of the plurality of guide collets, wherein each spindle cap of the plurality of spindle caps can be connected to the guide bush for cooperation with the guide collet to which the respective spindle cap is adapted.

2. The guide bushing system according to claim 1, further comprising a plurality of actuators respectively adapted to at least one design of one of the plurality of guide collets, wherein each actuator is configured for cooperation with the drive and with the guide collet to which the respective actuator is adapted.

3. The guide bushing system according to claim 1, wherein the plurality of guide collets has at least one pull collet.

4. The guide bushing system according to claim 1, wherein the plurality of guide collets has at least one thrust collet.

5. The guide bushing system according to claim 1, wherein the plurality of guide collets has at least one double-cone collet.

6. The guide bushing system according to claim 1, wherein the plurality of guide collets has at least one standard guide collet.

7. The guide bushing system according to claim 2, wherein the plurality of actuators has at least one pull piece.

8. The guide bushing system according to claim 2, wherein the plurality of actuators has at least one thrust piece.

9. The guide bushing system according to claim 2, wherein the plurality of guide collets comprises at least two guide collets of different design selected from the plurality of guide collets comprising a pull collet, a thrust collet, a double-cone collet and a standard guide collet.

10. The guide bushing system according to claim 2, wherein each actuator of the plurality of actuators is detachably connected to the drive.

11. The guide bushing system according to claim 1, wherein each spindle cap has a thread which is designed to be screwed to a thread provided on the guide bush.
